(19) United States
(12) Patent Application Publication
(10) Pub. No.: US 2026/0042979 A1
(43) Pub. Date: Feb. 12, 2026

(54) Process for the Preparation of a Powder or of a Pastille

(71) Applicant: Symrise AG, Holzminden (DE)

(72) Inventors: Julian Alexander GEORGI, Kassel (DE); Thorsten BÖDDEKER, Holzminden (DE); Nelli AHRENS, Reinbeck (DE); Jonas MEISEL, Uslar (DE); Bennet GRIMM, Höxter-Stahle (DE); Malayko Montilla Martinez, Holzminden (DE)

(21) Appl. No.: 18/998,441

(22) PCT Filed: Aug. 1, 2023
(86) PCT No.: PCT/EP2023/071251

§ 371 Date: Jan. 24, 2025

(30) Foreign Application Priority Data
Aug. 4, 2022 (WO) PCT/EP2022/071971

(51) Int. Cl. C11D 9/44; C11D 7/10; C11D 7/26; C11D 11/00; C11D 17/00; C11D 17/06

(52) U.S. Cl. CPC C11D 9/442; C11D 7/10; C11D 7/261; C11D 11/0082; C11D 17/0039; C11D 17/06; C11D 2111/12

(57) ABSTRACT

The present invention relates to the field of perfumed particles in particular for solid consumer product formulations such as textile care products or the like. More specifically, the present invention relates to a process for the preparation of a powder or of a pastille, consisting of or comprising a plurality of microcapsules containing one or more ingredients. Moreover, the present invention relates to a powder or a pastille obtained by the process. The present invention further relates to a consumer product comprising a powder or a pastille or more pastilles according to the invention and the use of a powder or a pastille for perfuming a consumer product according to the invention.

### FIELD OF THE INVENTION

The present invention relates to the field of perfumed particles in particular for solid consumer product formulations such as textile care products or the like. More specifically, the present invention relates to a process for the preparation of a powder or of a pastille, consisting of or comprising a plurality of microcapsules containing at least one active ingredient. Moreover, the present invention relates to a powder, or a pastille obtained by the process according to the present invention. The present invention further relates to a consumer product comprising a powder or a pastille or more pastilles, i.e. a plurality of pastilles, according to the invention and the use of a powder or a pastille according to the invention for perfuming a consumer product according to the invention.

### BACKGROUND OF THE INVENTION

Nowadays many consumer products such as detergents, fabric softeners, washing powders, deodorants, lotions, etc. are perfumed with fragrance materials or contain cosmetic ingredients to deliver a specific effect.

Unfortunately, often, for example, the fragrant substances or cosmetic ingredients of such products interact with other components of the product formulation, or the more volatile components of the perfume formulation tend to evaporate prematurely. Consequently, this leads to an undesired change and/or decrease of the desired effect, e.g. the fragrance impression or to a premature “use” of the cosmetic ingredient over time or might even cause disadvantageous reactions with the other ingredients of the product formulation resulting in a reduced product quality and/or stability. In order to prevent possible interactions of the fragrances or other active components with the other ingredients of the product or, for example, to prevent the volatilization of the fragrances and thus not to distort or reduce the desired olfactory impression, the fragrances or other active ingredients can be added to the formulation in encapsulated form. In this way, for example the desired olfactory impression can be guaranteed based on a targeted release of the active component. Moreover, interactions between the product components can be reduced allowing for improved product quality and storage stability.

Therefore, a broad variety of consumer products comprise encapsulated active ingredients such as fragrances in their formulations. For example, textile care formulations such as liquid detergents or fabric softeners comprise a plurality of such perfumed microcapsules. Additionally, said formulations require the incorporation of preservatives in order to increase their stability and durability such as methylisothiazolinone (MIT) which can cause allergic reactions or skin irritations, while powdered detergents usually do not require the addition of preservatives and cause a reduced environmental pollution. However, the incorporation of microcapsules into powdered formulations such as powdered detergents is considerably aggravated as a mixing of the microcapsule component and the other solid detergent components leads to breakage of the fragile microcapsules resulting in a loss of for example olfactory performance.

It is particularly difficult to produce microcapsules that have both good stability and good release properties. The ability of the capsules to retain the active ingredient and thus to prevent the loss of volatile components depends in particular on the stability of the capsules in the product base. However, very stable microcapsules, e.g. capsules having a comparably thick capsule wall, usually tend to exhibit a low performance as the targeted break of the microcapsules and thus the release of the active ingredient(s) is hindered. However, if they are too unstable, they are already destroyed during storage or manufacturing or result in a leakage of the active ingredient and do not perform either. Thus, an increase of the capsule wall, i.e. a multi-layered microcapsule shell or a thicker shell, respectively, likewise result in a decreased performance as the targeted release of the active ingredient is aggravated and said microcapsules usually require a complex multi-step preparation process.

In addition, there is a new and increasing trend towards solid consumer products such as solid hair care products, soaps and solid body wash in view of the public's increased ecological awareness (less waste, less preservatives, etc.), so that solid consumer products will become more and more relevant not only in the cosmetic industry but also in other industries. However, as indicated above, the incorporation of microcapsules into powdered formulations is considerably aggravated as a mixing of the microcapsule component and the other usually solid detergent components leads to breakage of the fragile microcapsules.

Consequently, there is a need to improve the efficient incorporation of actives such as perfuming ingredients into solid consumer product formulations, which however, simultaneously allow for an efficient and targeted release of said active.

Particularly, there is a need to provide said formulations comprising said actives, wherein said actives are provided with improved efficiencies and stabilities.

Particularly, there is a need to provide compositions comprising said actives for use in such consumer product formulations, in particular textile treatment compositions, with improved olfactory performances and stabilities.

Simultaneously, in order to cover the high demand, the compositions for solid consumer product formulations should be obtained more easily and the resulting compositions should show improved properties, e.g. in terms of their olfactory qualities.

### SUMMARY OF THE INVENTION

The present invention was made in view of the disadvantages described above. To solve the above-mentioned drawbacks, the present invention provides a method for the preparation of a composition, allowing for the efficient incorporation of active ingredients with improved olfactory performances and stabilities into solid consumer product formulations and for the preparation of consumer products as such.

Thus, in a first aspect the present invention relates to a process for the preparation of a powder or of a pastille, consisting of or comprising a plurality of microcapsules containing one or more active ingredients, consisting of or comprising the following steps:
(i) mixing (a) at least one anhydrous alkaline earth or alkali metal salt or a mixture of at least one anhydrous alkaline earth metal salt and at least one anhydrous alkali metal salt, (b) at least one capsule slurry or at least one capsule and (c) optionally at least one humectant, wherein the humectant is selected from the group consisting of: propylene glycol or ethylene glycol or dipropylene glycol or glycerol or sorbitol or maltitol;
(ii) heating the mixture obtained in step (i) and generating a melt;
(iii) dropping the melt produced in step (ii) onto a surface of an object;
(iv) seeding and optionally cooling the melt dropped in step (iii) in order to at least partially crystallize the dropped melt; and
(v) collecting the obtained powder or the pastille.

In a preferred embodiment, the at least one anhydrous alkaline earth or alkaline metal salt is/are potassium acetate and/or potassium citrate and/or potassium phosphate and/or magnesium oxalate and/or magnesium sulfate and/or magnesium acetate and/or magnesium citrate and/or magnesium phosphate and/or magnesium oxalate and/or calcium sulfate and/or calcium acetate and/or calcium citrate and/or calcium phosphate and/or calcium oxalate. It was found that these anhydrous salts are particularly suitable for the preparation of the powder/pastille compositions according to the present invention and provide for an excellent protection of the fragile microcapsules embedded therein while simultaneously providing for excellent release properties.

More preferably, the at least one anhydrous alkaline earth or alkaline metal salt is sodium sulfate and/or sodium acetate and/or potassium citrate. Best crystallisation behaviour and protection of the fragile microcapsules were observed when using these salts.

According to a most preferred embodiment, the salt component is a sulfate, citrate or phosphate. This avoids the formation of acetic odour notes in the final product formulation.

According to a second aspect the present invention relates to a powder, or a pastille (or a plurality of pastilles) obtained by the process according to present invention.

Additionally, in a further aspect, the present invention relates to a consumer product selected from the group consisting of: detergents and cleaning agents, personal care products, nutritional or recreational preparations, cosmetic or pharmaceutical preparations, perfumed products or products to be perfumed, preferably fragrance rinsers, laundry perfumes, the product comprising a powder or a pastille or more pastilles, i.e. at least one pastille, according to the invention.

Finally, the present invention relates to the use of a powder or pastille according to the invention for perfuming a consumer product, preferably a consumer product according to the present invention.

That is, the inventors have found that the process for the preparation of a powder or of a pastille according to the invention allows to provide such a powder or a pastille for an efficient incorporation of active ingredients in encapsulated form which show excellent release properties (performance) into a broad range of solid consumer product formulations and consumer products as such. Thereby, microcapsules encapsulated by crystallized salts are obtainable that serve as a buffer protecting the fragile microcapsules during the preparation of the final consumer product (formulation) from mechanical, chemical and/or thermal influences without negatively influencing the performance of the microcapsules within the consumer product (formulation). Based thereon the present dosage form allows for an efficient incorporation of active ingredients via microcapsules in solid consumer product formulations while simultaneously allowing for an efficient and targeted release of said active ingredients thus overcoming the drawbacks of the state of the art. The fragile microcapsules are embedded in crystals forming a powder or a pastille which even withstands harsh chemical and physical conditions. Based on the method as specified herein, it was possible to obtain a stable but simultaneously flexible protective matrix that allows for a targeted release of the active ingredients from the microcapsules embedded in said protective salt matrix.

The present problem is solved by the objects of the independent patent claims. Preferred embodiments are apparent from the wording of the dependent patent claims as well as the following description.

All percentages are by weight unless otherwise indicated. Numeric examples given in the form “x to y” include the values given. When multiple preferred numeric ranges are specified in this format, all ranges created by combining the various endpoints are also included.

The terms “at least one” or “one or more” as used herein refers to 1 or more, for example 2, 3, 4, 5, 6, 7, 8, 9 or more.

The term “and/or” expresses that a linkage exists, or an alternative is provided.

### BRIEF DESCRIPTION OF DRAWINGS

FIG. 1 shows sensory evaluation results of the performance (i.e. release properties) of pastilles according to the invention incorporated in a washing detergent.

FIG. 2 shows sensory evaluation results of the performance (i.e. release properties) of pastilles according to the invention incorporated in a laundry soap.

FIG. 3 shows a comparison of sensory evaluation results of the performance (i.e. release properties) of different pastilles according to the invention each incorporated in a washing detergent.

FIGS. 4a and 4b show the influence of the humectant sorbitol.

FIG. 5 shows the influence of the humectant glycerol.

FIG. 6 shows the influence of the humectant polypropylene glycol.

FIGS. 7a and 7b show the influence of hydrated salts.

FIG. 8 shows the influence of seeding during the process (FIG. 8a: without seeding; FIG. 8b: with seeding).

FIG. 9: FIG. 9 shows sensory evaluation results of the performance (i.e. release properties) of pastilles according to the invention incorporated in a washing detergent.

### DETAILED DESCRIPTION OF THE INVENTION

Hereinafter, the present invention is described in more detail.

Thus, in a first aspect the present invention relates to a process for the preparation of a powder or of a pastille, consisting of or comprising a plurality of microcapsules containing one or more ingredients, consisting of or comprising the following steps:
(i) mixing (a) at least one anhydrous alkaline earth or alkali metal salt or a mixture of at least one anhydrous alkaline earth metal salt and at least one anhydrous alkali metal salt, (b) at least one capsule slurry or at least one capsule and (c) optionally at least one humectant, wherein the humectant is selected from the group consisting of: propylene glycol or ethylene glycol or dipropylene glycol or glycerol or sorbitol or maltitol;
(ii) heating the mixture obtained in step (i) and generating a melt;
(iii) dropping the melt produced in step (ii) onto a surface of an object;
(iv) seeding and optionally cooling the melt dropped in step (iii) in order to at least partially crystallize the dropped melt; and
(v) collecting the obtained powder or the pastille.

Preferably, a humectant is also comprised in the composition according to the invention.

It was surprisingly found that such inorganic compositions allow for an efficient incorporation into a broad variety of consumer product formulations, in particular solid consumer product formulations as the fragile microcapsules tend to break or get crushed upon mixing them with the other (solid) components of the consumer product formulations.

The present invention was made in view of the disadvantages described above. To solve the above-mentioned drawbacks, the present invention provides a composition and a method for the preparation thereof, allowing for the efficient incorporation of active ingredients with improved olfactory performances and stabilities into solid consumer product formulations and/or for the preparation of consumer products as such.

It is essential to the invention that the at least one alkaline earth or alkali metal salt is an anhydrous alkaline earth or alkali metal salt due to the general entropy effect of such anhydrous salts. Using water-containing salts did not provide for the desired properties, i.e. increased stability and improved performance. Moreover, the products obtained using water-containing salts could not be incorporated into solid consumer product formulations and showed insufficient storage stabilities.

According to present invention, an anhydrous alkaline earth or alkali metal salt could be considered as a salt having no water molecules attached to the salt molecules. Moreover, said anhydrous alkaline earth or alkali metal salt could be considered as having no water molecules in the salt crystals, preferably as they are each commercially available as their so-called water-free salts.

Accordingly, within the scope of the present invention, no hydrates are used. Hydrates are salts containing water molecules combined in a definite ratio as an integral part of the crystal at are either bound to a metal centre or that have crystallized with the metal complex (water of crystallization or water of hydration).

Due to the entropy effect, the mixture comprising (a) at least one anhydrous alkaline earth or alkali metal salt or a mixture of at least one anhydrous alkaline earth metal salt and at least one anhydrous alkali metal salt, (b) at least one capsule slurry comprising at least one microcapsule containing at least one active ingredient or at least one capsule containing at least one active ingredient and (c) optionally at least one humectant crystallizes after heating and generating a melt (step (i)) and after dropping the melt onto a surface of an object (step (iii)).

According to a preferred embodiment the microcapsules are added as such to the composition according to the present invention. Thereby each microcapsule comprises at least one active ingredient.

The microcapsules of the composition according to the present invention can be any of those known to the person skilled in the art.

Preferably, the microcapsules used within the scope of the present invention are such microcapsules, wherein the shell of the at least one microcapsule comprises or consists of a shell material selected from the group consisting of: sol-gel polymer (e.g., silica), polysiloxane, polyacrylate, polyacrylamide, poly (acrylate-co-acrylamide), polyurea, polyurethane, polyamide, polypeptide, polysulfonate, polysaccharide, polyphenolic polymers, poly(melamine-formaldehyde), poly(resorcinol-formaldehyde), poly(urea-formaldehyde), poly(melamine-urea), or combinations thereof, and preferably selected from the group consisting of sol-gel polymer, polyacrylate, polyacrylamide, poly (acrylate-co-acrylamide), polyurea, polyurethane, polypeptide, polysaccharide, polyphenolic polymers, poly(melamine-formaldehyde), poly(resorcinol-formaldehyde), poly(urea-formaldehyde), or combinations thereof.

The compositions according to the present invention comprise at least one of said microcapsules, i.e. either a single of the above mentioned types of microcapsules is embedded in the polymer matrix of the invention, or two or more different microcapsules up to a plurality of microcapsules can be embedded in the polymer matrix. Thereby, all microcapsules can be of the same type, i.e. all microcapsules are for example poly(melamine-formaldehyde)-based, or some of the microcapsules of component a) are for example poly(melamine-formaldehyde)-based and others are polyurea-based, i.e. component a) can comprise or consist of a mixture of different types of microcapsules being based on different encapsulation materials/shell materials.

Moreover, the microcapsules used within the compositions according of the present invention can be loaded with different materials, such as with different active ingredients, i.e. the compositions according to the invention comprise different microcapsules differing in their core material. However, according to a further preferred variant, all microcapsules comprise the same active ingredient(s).

According to a further preferred variant, the compositions according to the invention comprise different microcapsules both differing in their core material as well as their shell material.

Preferably, however, the microcapsules according to component a) of the present invention are selected from the following group of capsule types consisting of: poly(melamine-formaldehyde)-based microcapsules and isocyanate-based microcapsules such as polyurea-based and/or polyurethane-based microcapsules and mixtures thereof and which are preferably biodegradable.

According to another preferred embodiment the microcapsules are added in the form of an aqueous dispersion (microcapsule slurry) to the composition according to the present invention. A capsule slurry is a dispersion of capsules in water, and the capsule content is usually between 25% and 40% by weight based on the total slurry.

Preferably, a capsule slurry is used for the preparation of the compositions according to the present invention. This allows for the facilitated preparation of more stable and more flexible compositions while simultaneously allowing for an efficient targeted release of the active ingredients.

Advantageously, the mixture crystallizes in a disordered way due to the entropy effect. This could further be described as a spontaneous crystallization which takes place and enables to obtain a powder or pastilles having increased stabilities.

In the context of the invention, a powder or a pastille can be denoted as a microcapsule or could at least contain a microcapsule. Particularly, the invention can be understood in such a way that the process for the preparation of a powder or of a pastille could be understood as a process for the preparation of a microcapsule in form of a powder or a pastille.

Consequently, the invention relates to a process for the preparation of a powder or of a pastille according to the invention allows, starting from the at least one capsule slurry or one capsule, to provide microcapsules with increased stabilities. Those stabilities are justified by the presence of disordered crystallized alkaline earth and/or alkali metal salt used. Simultaneously the as obtained compositions are not brittle but rather show some degree of flexibility thereby allowing for the efficient and stable incorporation into solid consumer product formulations upon manufacturing as well as storage.

In general, microcapsules are particles comprising a core and a wall material surrounding the core, wherein the core may be a solid, liquid or gaseous substance or substance mixture surrounded by a polymeric dense, permeable or semi-permeable wall material. The wall is usually formed by precipitation of the polymers upon emulsification and coacervation or interfacial polymerization. The core is also referred to as the inner phase. Other names used for the wall include outer phase, shell or coating. The shell wall can comprise one or more layers and can comprise an additional coating with a coating substance. The diameter of the microcapsules typically varies in the range of 1 μm to 1,000 μm. The wall thickness is typically 0.5 μm to 150 μm but can be varied in the range of 5·10⁻⁹ m to 5·10⁻⁶ m. Typically loadings of 25 wt.-% to 95 wt.-% with core material, but also those of 1 wt.-% to 99 wt.-% are possible.

For example, hydrophobic active ingredients, such as single fragrances (also referred to as fragrant/odorous substances or fragrance substances), fragrance mixtures (also referred to as mixtures of fragrant/odorous substances or mixtures of fragrance substances or perfume oils), aroma substances or mixtures of aroma substances, can be easily incorporated into numerous and diverse application formulations through encapsulation.

Based on their properties, microcapsules are used in the printing industry, food industry (vitamins, flavours, plant extracts, enzymes, microorganisms), agricultural chemistry (fertilizers, pesticides), feed industry (minerals, vitamins, enzymes, drugs, microorganisms), pharmaceutical industry, detergent industry, and cosmetic industry, among others.

A variety of capsule wall or coating materials are known for the manufacture of microcapsules. The capsule wall can be made of either natural, semi-synthetic or synthetic materials. Natural shell materials include gum arabic, agar-agar, agarose, maltodextrins, alginic acid or its salts, e.g., sodium alginate or calcium alginate, fats and fatty acids, cetyl alcohol, collagen, chitosan, lecithins, gelatine, albumin, shellac, polysaccharides such as starch or dextran, polypeptides, protein hydrolysates, sucrose, and waxes. Semisynthetic capsule wall materials include chemically modified celluloses, especially cellulose esters, and cellulose ethers, e.g., cellulose acetate, ethyl cellulose, hydroxypropyl cellulose, hydroxypropyl methyl cellulose, and carboxymethyl cellulose, as well as starch derivatives, in particular starch ethers and starch esters. Synthetic shell materials are, for example, polymers such as polyacrylates, polyamides, polyvinyl alcohol or polyvinylpyrrolidone.

Depending on the type of capsule wall material and manufacturing process, microcapsules with different properties in terms of diameter, size distribution, and physical and/or chemical properties are formed in each case.

Preferably, the microcapsules used within the scope of the present invention are such microcapsules, wherein the shell of the at least one microcapsule comprises or consists of a shell material selected from the group consisting of: sol-gel polymer (e.g., silica), polysiloxane, polyacrylate, polyacrylamide, poly (acrylate-co-acrylamide), polyurea, polyurethane, polyamide, polypeptide, polysulfonate, polysaccharide, polyphenolic polymers, poly(melamine-formaldehyde), poly(resorcinol-formaldehyde), poly(urea-formaldehyde), poly(melamine-urea), or combinations thereof.

Preferably, the microcapsules according to the present invention are selected from the following group of capsule types consisting of: poly(melamine-formaldehyde)-based microcapsules and isocyanate-based microcapsules such as polyurea-based and/or polyurethane-based microcapsules which are preferably biodegradable.

In the context of the present invention, microcapsules are understood to be microparticles comprising at least one or more active ingredient(s) as core material inside the capsule and which are enclosed by a capsule shell or capsule wall as specified above. As active ingredient to be encapsulated according to the invention, basically any material suitable for inclusion in microcapsules can be considered in the process according to the invention. Preferably, hydrophobic or lipophilic, i.e., water-insoluble, or water-immiscible liquids or solids as well as suspensions can be considered as active ingredients to be encapsulated. These are predominantly non-polar substances. Such hydrophobic substances are almost always lipophilic, i.e., they dissolve well in fat and oil.

The terms “microcapsule” and “capsule” or “hydrophobic” and “lipophilic” are used synonymously within the context of the present invention.

As indicated above, the microcapsules can be directly comprised in the compositions according to the present invention, or alternatively, be comprised in the form of a microcapsule slurry, i.e. an aqueous dispersion of microcapsules.

The microcapsules according to the present invention comprise at least one active ingredient as the core material (irrespective if added directly or as microcapsule slurry).

In the context of the present description, the core material is preferably a hydrophobic active substance, i.e., a substance that has a specific effect or causes a specific reaction, for example, a drug, a pesticide, a cosmetic active ingredient, a food active ingredient, etc. Particularly, the hydrophobic active substance is a lipophilic or hydrophobic fragrance or aroma substance or a lipophilic or hydrophobic perfume oil or aroma (i.e. a mixture of fragrance substances or aroma substances, respectively), a cooling agent, a TRPV1 or a TRPV3 modulator, a substance that produces a pungent taste or a warmth or heat sensation on the skin or mucous membranes or a tingling sensation in the mouth or throat, or active ingredients with astringent effect, a pesticide, a biocide, an insecticide, a substance from the group of repellents, a food additive, a cosmetic active ingredient, a pharmaceutical active ingredient, a dye, a dye precursor; an agrochemical, a dye, a luminous paint, an optical brightener, a solvent, a wax, a silicone oil, a lubricant, a print coating for paper, or a mixture of two or more of the aforementioned active ingredients.

The microcapsules in the context of present invention might have a core material in the form of a hydrophobic single fragrant substance or single odorant substance, wherein the core material comprises at least one single fragrant substance or single odorant substance or mixtures thereof, selected from one or more of the following groups:

Extracts of natural raw materials and also fractions thereof or components isolated therefrom; single fragrance substances from a group of hydrocarbons; aliphatic alcohols; aliphatic aldehydes and acetals; aliphatic ketones and oximes; aliphatic sulfur-containing compounds; aliphatic nitriles; esters of aliphatic carboxylic acids; formates, acetates, propionates, isobutyrates, butyrates, isovalerates, pentanoates, hexanoates, crotonates, tiglinates and 3-methyl-2-butenoates of acyclic terpene alcohols; acyclic terpene aldehydes and ketones as well as their dimethyl and diethyl acetals; formates, acetates, propionates, isobutyrates, butyrates, isovalerates, pentanoates, hexanoates, crotonates, tiglinates and 3-methyl-2-butenoates of cyclic terpene alcohols; cyclic terpene aldehydes and ketones; cyclic alcohols; cyclic and cycloaliphatic ethers; cyclic and macrocyclic ketones; cycloaliphatic aldehydes; cycloaliphatic ketones; esters of cyclic alcohols; esters of cycloaliphatic carboxylic acids; aromatic hydrocarbons; araliphatic alcohols; esters of araliphatic alcohols and aliphatic carboxylic acids; araliphatic ethers; aromatic and araliphatic aldehydes; aromatic and araliphatic ketones; aromatic and araliphatic carboxylic acids and their esters; nitrogen-containing aromatic compounds; phenyl ethers and phenyl esters; heterocyclic compounds; lactones; and mixtures of the above active ingredients.

Specific examples of the abovementioned substances are known to the person skilled in the art. Fragrant substances or odorant substances and mixtures of two or more of said substances are chemical substances or compositions which are used to confer, impart and/or modulate a specific odour or odour impression. Preferably, said odour (impression) is considered as being pleasant.

The term “fragrance” refers to encapsulated fragrances. The terms “fragrance”, “encapsulated fragrance” and “perfume” can be used interchangeably.

In an alternative embodiment according to the present invention, the microcapsules according to the invention use a fragrance substance or a perfume oil, respectively, or an aroma substance or an aroma as the active ingredient to be encapsulated or as the core material. These are compositions containing at least one fragrance substance or one aroma substance. Such compositions, in particular mixtures of fragrance substances or perfume oils, preferably comprise two, three, four, five, six, seven, eight, nine, ten or more fragrance substances.

The fragrance mixtures or perfume oils, respectively, are preferably selected from the group of extracts from natural raw materials, such as essential oils, concretes, absolutes, resins, resinoids, balsams, tinctures such as e.g., Ambergris oil; Amyris oil; Angelica seed oil; Angelica root oil; Anise oil; Valerian oil; Basil oil; Tree moss absolute; Bay oil; Mugwort oil; Benzoin resin; Bergamot oil; Beeswax absolute; Birch tar oil; Bitter almond oil; Savory oil; Bucco leaf oil; Cabreuva oil; Cade oil; Calmus oil; Camphor oil; Cananga oil; Cardamom oil; Cascarilla oil; Cassia oil; Cassie absolute; Castoreum absolute; Cedar leaf oil; Cedarwood oil; Cistus oil; Citronella oil; Citron oil; Copaiva balsam; Copaiva balsam oil; Coriander oil; Costus root oil; Cumin oil; Cypress oil; Davana oil; Dill herb oil; Dill seed oil; Eau de brouts absolute; Oak moss absolute; Elemi oil; Tarragon oil; Eucalyptus citriodora oil; Eucalyptus oil; Fennel oil; Spruce needle oil; Galbanum oil; Galbanum resin; Geranium oil; Grapefruit oil; Guaiac wood oil; Gurjun balsam; Gurjun balsam oil, Helichrysum absolute; Helichrysum oil; Ginger oil; Iris root absolute; Iris root oil; Jasmine absolute; Calamus oil; Chamomile oil blue; Chamomile oil Roman; Carrot seed oil; Cascarilla oil; Pine needle oil; Curly mint oil; Caraway seed oil; Labdanum oil; Labdanum absolute; Labdanum resin; Lavandin absolute; Lavandin oil; Lavender absolute; Lavender oil; Lemongrass oil; Lovage oil; Lime oil distilled; Lime oil pressed; Linal oil; Litsea cubeba oil; Bay leaf oil; Macis oil; Marjoram oil; Mandarin oil; Masso bark oil; Mimosa absolute; Musk grain oil; Musk tincture; Muscat sage oil; Muscat oil; Myrrh absolute; Myrrh oil; Myrtle oil; Clove leaf oil; Clove flower oil; Neroli oil; Olibanum absolute; Olibanum oil; Opopanax oil; Orange flower absolute; Orange oil; Origanum oil; Palmarosa oil; Patchouli oil; Perilla oil; Perubalsam oil; Parsley leaf oil; Parsley seed oil; Petitgrain oil; Peppermint oil; Pepper oil; Pimento oil; Pine oil; Poley oil; Rose absolute; Rosewood oil; Rose oil; Rosemary oil; Sage oil Dalmatian; Sage oil Spanish; Sandalwood oil; Celery seed oil; Spicy lavender oil; Star anise oil; Styrax oil; Tagetes oil; Fir needle oil; Tea tree oil; Turpentine oil; Thyme oil; Tolu balsam; Tonka absolute; Tuberose absolute; Vanilla extract; Violet leaf absolute; Verbena oil; Vetiver oil; Juniper berry oil; Wine yeast oil; Wormwood oil; Wintergreen oil; Ylang oil; Hyssop oil; Civet absolute; Cinnamon leaf oil; Cinnamon bark oil; and fractions thereof or ingredients isolated therefrom.

In a further variant of the invention, aroma substances can also be encapsulated as a core material in the form of a single aroma, wherein the core material comprises at least one single aroma substance or mixtures thereof as active ingredient.

However, preferably a single fragrant substance or odorous substance (i.e., chemical compounds having a smell or odour and thus all natural and synthetic substances that impart an olfactorily perceptible odour) or alternatively a mixture of fragrant substances or odorous substances (so-called perfume oil) is used as the active ingredient enclosed by the microcapsule shell. More preferably, said substances and mixtures of substances are imparting a pleasant odour to a consumer product.

In a preferred variant of the present invention, all microcapsules comprised by the powder or pastille according to the invention are loaded with the same active ingredient(s), for example all of the microcapsules are comprising a fragrance substance and even more preferred the same fragrance substance.

According to an alternative embodiment, the microcapsules comprised by the powder or pastille according to the invention are encapsulating different classes of active ingredients or different substances among the same class of active ingredients. For example, some of the microcapsule comprise a specific fragrance substance while other microcapsules enclose another fragrance substance.

Thereby, preferably the core material is selected irrespective of the shell material.

Thus, according to a further preferred variant of the present invention, the pastilles of the present invention can comprise one type of microcapsules or a mixture of two or more different types of microcapsules. Thereby, the microcapsules can vary in terms of the active ingredient composition (i.e. the microcapsule core) and/or the wall composition (i.e. the material of the capsule shell).

A single pastille or powdered composition of the present invention may comprise between 0.5% by weight to 10% by weight of microcapsule(s) as specified above based on the total weight of the pastille or powdered composition.

Thus, between 0.5% by weight to 10% by weight of microcapsules can be incorporated into the final composition based on the total weight of the pastille, i.e. a single pastille of the composition according to the present invention comprises between 0.5% by weight to 10% by weight of microcapsule(s) as specified above. If the amount of the microcapsule component is kept within these ranges, a homogeneous distribution of the microcapsules within the pastille(s) can be achieved. Moreover, if the amount of component (b) is within the above ranges the active ingredients can efficiently be incorporated into the final solid consumer product formulation due to an efficient protection by the surrounding salt matrix, i.e. the microcapsules do not break open during the preparation process of the solid consumer product and thus can effectively retain the encapsulated active ingredient(s) without loss, resulting in a significantly improved microcapsule performance as shown in the experimental section.

According to a preferred embodiment, the amount of the microcapsule(s) ranges from 0.5% by weight to 10% by weight based on the total weight of the powder or of the pastille and even more preferred from 3% by weight to 8% by weight based on the total weight of the pastille or powder.

The microcapsules can directly be incorporated into the compositions of the present invention, or alternatively can be added in the form of a capsule slurry.

The inventive compositions comprising the microcapsules encapsulating the active ingredient(s) are efficiently incorporated into a variety of solid consumer product formulations allowing for an efficient and targeted release of the active ingredient(s). Thereby the presence of crystallized inorganic salts acts as kind of a shock absorbing layer protecting the microcapsules from damage due to mechanical, chemical and/or thermal influences and thus premature release and degradation of the active ingredient(s) during the preparation process of the consumer product.

It is additionally advantageous if powder particles of the powder or the pastille each having a diameter ranging from 100 μm to 1 cm, preferably from 500 μm to 3 mm in order to achieve an ideal distribution of the pastilles within the final solid consumer product formulation and thus in turn of the microcapsules embedded therein. Too big pastilles result in an inhomogeneous distribution.

Said pastilles or granules are preferably present in the shape of tablets, pills, spheres, and the like, having a spherical, hemispherical, compressed hemispherical, lentil shaped, and oblong shape and can be prepared by any method known in the art by those skilled in the art.

Moreover, the powder or pastilles of the invention and the microcapsules respectively may further comprise one or more ingredients which improve the visual aesthetics of the final consumer product such as colourants. In addition, additive and/or active ingredients such as optical brighteners, cleaning agents, laundry actives and the like could be comprised by the powder or pastilles.

### Process for the Preparation:

In a first step (i) of the process according to the present invention (a) at least one anhydrous alkaline earth or alkali metal salt or a mixture of at least one anhydrous alkaline earth metal salt and at least one anhydrous alkali metal salt is mixed with (b) at least one capsule slurry or at least one capsule (wherein the capsules contain at least one active ingredient) and (c) optionally at least one humectant.

In the context of the present invention, the components specified above likewise apply here, i.e. the terms “microcapsule”, “anhydrous salt”, “humectant”, “pastille” etc. as well as the corresponding amounts and properties as specified above.

Preferably, the compositions according to the present invention comprise a humectant. Therefore, in further preferred variant of the present invention in a first step (i) of the process according to the present invention (a) at least one anhydrous alkaline earth or alkali metal salt or a mixture of at least one anhydrous alkaline earth metal salt and at least one anhydrous alkali metal salt is mixed with (b) at least one capsule slurry or at least one capsule (wherein the capsules contain at least one active ingredient) and (c) at least one humectant.

Preferably, the humectant is selected from the group consisting of propylene glycol or ethylene glycol or dipropylene glycol or glycerol or sorbitol or maltitol. It was found that these humectants are particularly suitable for the preparation of a powder or pastille according to the present invention. The use of such polyols allows for the preparation of highly stable products which can be incorporated into various consumer product formulations. Other substances such as microfibrillated cellulose and the like did not achieve the desired properties.

Preferably, as alkaline earth or alkali metal salt anhydrous lithium sulfate and/or lithium acetate and/or lithium citrate and/or lithium phosphate and/or lithium oxalate and/or sodium sulfate and/or sodium acetate and/or sodium citrate and/or sodium phosphate and/or sodium oxalate and/or potassium sulfate and/or potassium acetate and/or potassium citrate and/or potassium phosphate and/or magnesium oxalate and/or magnesium sulfate and/or magnesium acetate and/or magnesium citrate and/or magnesium phosphate and/or magnesium oxalate and/or calcium sulfate and/or calcium acetate and/or calcium citrate and/or calcium phosphate and/or calcium oxalate. These are preferred salts as component (a).

Particularly sodium sulfate and/or sodium acetate and/or potassium citrate is/are used to obtain a powder or a pastille with significantly improved stability properties while simultaneously allowing for an efficient and targeted release of the active ingredients.

The crystalline salt matrix protects the microcapsules towards chemical and mechanical influences while allowing for high release performances. Said protection allows an efficient incorporation of the loaded microcapsules into a broad range of consumer product formulations and in particular solid consumer product formulations. In the manufacture of such compositions the fragile microcapsules are subject to high shearing which causes a breakage of the microcapsules and thus a premature release of the active ingredients. It was surprisingly found that the compositions according to the present invention can be advantageously incorporated into such formulations thereby showing improved performances and chemical and mechanicals stabilities within these formulations, during their manufacture and towards the other ingredients.

Suitable components (b) are specified above.

According to present invention, a humectant is a hygroscopic substance used to keep moist of the mixture to be produced in step (i).

Preferably, a polyol, more preferably an aliphatic polyol, even more preferably propylene glycol or ethylene glycol or dipropylene glycol or glycerol or sorbitol or maltitol or a mixture thereof is used as the humectant.

Preferably, the at least one encapsulated active ingredient is selected from the group consisting of odorants, fragrances, scents, perfume oils, flavourings, cosmetic ingredients, pharmaceutical active ingredients, insect repellents, ingredients for oral and dental care products, latent heat storage media and adsorbents. More preferably, the ingredient is an odorant or fragrance or a perfume oil and is added in a proportion of 0% to 10% by weight, preferably 0% to 6% by weight based on the total weight of the pastille or powdered composition.

According to present invention, a capsule slurry or a capsule can be used.

Preferably, the capsule slurry is a dispersion of capsules in water. More preferably, in order to obtain a powder or a pastille with improved stabilities and improved sensory properties, the capsule content is between 25% and 65% by weight (and preferably 25% and 40% by weight) based on the total weight of the pastille or powdered composition. Alternatively, in case no capsule slurry but at least one capsule is used, the capsule content is between 1% and 80% by weight based on the total weight of the pastille or powdered composition.

According to another further preferred variant, the proportion of capsules is 10% to 70% by weight, or the proportion of a capsule slurry which is comprised in the compositions according to the present invention is 1% to 80% by weight (and even more preferred 10% to 40% by weight), based on the total weight of the pastille or powdered composition.

If the amount of the microcapsule component (b) is kept within these ranges, a homogeneous distribution of the microcapsules within the pastille(s) can be achieved. Moreover, if the amount of component (b) is within the above ranges the active ingredients can efficiently be incorporated into the final solid consumer product formulation due to an efficient protection by the surrounding salt matrix, i.e. the microcapsules do not break open during the preparation process of the solid consumer product and thus can effectively retain the encapsulated active ingredient(s) without loss, resulting in a significantly improved microcapsule performance as shown in the experimental section.

Preferably, the proportion of alkaline earth and/or alkali metal salt is 20% to 99% by weight.

According to a further preferred variant, the proportion of alkaline earth and/or alkali metal salt is 40% to 80% by weight based on the total weight of the pastille or powdered composition.

If the salt component specified above is comprised within said ranges in the compositions according to the present invention an efficient protection of the fragile microcapsules within said crystalline salt matrix can be achieved while simultaneously allowing for an efficient targeted release of the active ingredients.

According to another further preferred variant, a humected is comprised in the compositions according to the present invention. Preferably, the humectant is comprised in amounts of 0% to 5% by weight, based on the total weight of the pastille or powdered composition.

Preferably, the proportion of humectant is 0% to 2.5% by weight, and even more preferred 0.1% to 2.5% by weight, based on the total weight of the pastille or powdered composition.

It was surprisingly found that the presence of humectants considerably improves the stability and performance of the compositions according to the present invention. In addition, it was found that a comparison of the samples with and without a humectant shows that the addition of a humectant not only improves the manufacturing and preparation of more homogeneous pastilles but also results in an improvement of the sensory experience by allowing for a more efficient protection of the fragile microcapsules and thus a more targeted fragrance release. Surprisingly, the comprised humectant component further improves the final product properties allowing for an efficient adjustment of the viscosity and flexibility of the crystalline matrix resulting in a less brittle and more flexible matrix with improved buffering effect and thus better protection of the fragile microcapsules and a facilitated incorporation into solid consumer product formulations without altering the fundamental chemical character of the composition. Additionally, it was surprisingly found that the humectant component facilitates the pastille formation and significantly improves the miscibility of the microcapsule component and the salt component and further optional components or additives thereby allowing for achieving a more homogeneous distribution of the microcapsules (and thus the active ingredients) within the crystalline matrix. The addition of the humectant within the ranges specified above allows for efficiently adjusting the properties of the matrix resulting in a less brittle and more flexible matrix with improved buffering effect and thus better protection of the fragile microcapsules and a facilitated incorporation into solid consumer product formulations without altering the fundamental chemical character of the plasticized material.

Preferably, the proportion of alkaline earth and/or alkali metal salt is 20% to 99% by weight, the proportion of capsule is 10% to 70% by weight or the proportion of capsule slurry is 1% to 80% by weight and optionally the proportion of humectant is 0% to 2.5% by weight based on the total weight of the pastille or powdered composition. Surprisingly, this led to a powder or a pastille with improved stabilities and improved sensory properties.

In order to obtain a powder or a pastille with improved stabilities and improved sensory properties, the proportion of alkaline earth and/or alkali metal salt is 40% to 80% by weight, the proportion of capsule is 1% to 70% by weight or the proportion of capsule slurry is 1% to 80% by weight and the proportion of humectant is 0% to 5% by weight based on the total weight of the pastille or powdered composition.

In a subsequent step (ii) of the process according to the invention, the mixture obtained in step (i) is heated for obtaining a melt.

Preferably, the melting step (ii) is conducted at a temperature in the range from 40° C. to 80° C. in order to achieve a homogeneous distribution of discrete microcapsules in the crystalline buffering matrix. Preferably, the temperature ranges from 40° C. to 60° C. and even more preferred from 40° C. to 50° C.

In this step, additional additives such as adhesion agents, surfactants, plasticizers and/or structuring agents can be added and mixed to obtain a homogenous mixture.

In a subsequent step pastilles are formed by dripping the mixture/melt of step (ii) using state-of-the-art pastillation processes known to those skilled in the art.

Pastillation is a particle forming process, where usually a pastille is formed using a droplet former, followed by cooling of the as-obtained discrete particles. Processes for the preparation of pastilles or granules are commercially used methods and the pastilles may be formed into different shapes include tablets, pills, spheres, and the like. Moreover, up-scaling by dropping using a pulse generator in air or vegetable oil also showed good results.

Usually, a melt is dropped on a surface resulting into the formation of discrete pastilles.

In an embodiment of present invention, the surface is cooled before and/or during dripping in order to improve a crystallization process of the melt.

Thus, in a further process step (iii) of the present invention, the melt produced in step (ii) is dropped onto a surface of an object in order to at least partially crystallize the dropped melt, followed by a step (iv), namely seeding and optionally cooling the melt dropped.

Seeding describes the crystallization using a seed crystal. A seed crystal is a small piece of single crystal or polycrystal material from which a large crystal of typically the same material is grown, i.e. crystal seeding is a technique widely employed to provide preformed templates (seeds) on which new molecules can converge to form crystals. Usually, the seed crystal has the same composition as the final crystal. Such processes are known to the person skilled in the art.

Accordingly, within the scope of the present invention the seed crystal has the same composition as the anhydrous salt used in step (i) of the present invention.

Seeding allows for the formation of a homogenous and stable crystal salt matrix embedding the fragile microcapsules while simultaneously allowing for an efficient and targeted release of the active ingredients encapsulated in said microcapsules.

Seeding also has a significant effect on the reaction rate. During slow precipitation, i.e. slow formation of the salt matrix, the fragile capsules are pushed outwards. This results in an inhomogeneous capsule distribution. The fine and fragile capsules are thus not as well protected against external influences such as pressure and the like.

Surprisingly, it was found that seeding with a seed crystal significantly accelerates the formation of the salt matrix and contributes to a homogeneous distribution of the fragile capsules within this protective matrix. The microcapsules are thus much better protected, without negatively influencing the release properties.

Seeding influences the crystallization behaviour and thus also the final crystalline structure and therefore also the overall structure of the resulting composition according to the present invention. Crystals obtained via seeding show different properties compared to crystals which did not contain any seed crystals.

Also other components such as the presence of a humectant influence the crystallization behaviour and therefore the final structure and properties.

Finally, as a step (v), a powder or a pastille obtained is collected.

Generally, pastilles are formed by dripping the mixture of step (iii) using state-of-the-art pastillation processes known to those skilled in the art. Pastillation is a particle forming process, where usually a pastille is formed using a droplet former.

In order to achieve a homogeneous distribution of microcapsules, powder particles of the powder or the pastille each have a diameter ranging from 100 μm to 1 cm, preferably from 500 μm to 3 mm.

Additionally, in a further aspect of the present invention relates to compositions prepared according to the inventive process.

In an embodiment of the invention, powder particles of the powder or the pastilles each having a weight ranging having a weight of from 0.5 mg to 25 mg, preferably from 1 mg to 5 mg.

The compositions according to the present invention comprise or consist of at least one pastille having the compositions specified above. Preferably the compositions are present as a plurality of pastilles. Alternatively, the compositions are present as a single pastille of the above-specified compositions.

### Consumer Products:

Additionally, in another aspect, the present invention relates to the use of the powder or pastille(s) according to the invention for the preparation of consumer product formulations. The terms “consumer product formulation” and “consumer product” are used synonymously within the context of the present invention.

Particular advantages of the inventive powder or pastilles obtained by the process for preparation according to the invention were found in view of the preparation of solid consumer products such as powder detergents, laundry soaps, solid fabric softeners, deo sticks and the like. Thus, preferably the consumer product according to the present invention is a solid consumer product.

When incorporated into consumer product formulations, microcapsules have to be chemically stable in a rather aggressive environment but simultaneously also be mechanically stable when subjected to mechanical stress such as during the mixing and optionally pressing of a solid consumer product formulation. However, an increase in the shell thickness usually will result in worsened release properties (release of the active ingredient) due to a high capsule breakage during the processing caused by shearing. It was surprisingly found that the compositions according to the present invention, which are based on microcapsules embedded in a crystallin salt matrix are particularly suitable for the incorporation in solid consumer product formulations. The crystalline salt matrix protects the microcapsules while allowing for high release performances.

Therefore, in another preferred variant the present invention also relates to the use of the powder or pastille(s) according to the present invention for the preparation of consumer products and formulations thereof, wherein said consumer product or consumer product formulation is a solid product such as a textile care product (such as a powder detergent, laundry soap, solid fabric softener), a solid soap, a household product (such as a solid WC-cleaner, solid all-purpose cleaners, powdered carpet cleaners, powdery washing agents for washing dishes or for cleaning various surfaces), a personal care product (such as a deodorant, soap), scent boosters, fragrance enhancers, a pharmaceutical product, and mixtures thereof.

Finally, in another aspect the present invention relates to the consumer product or consumer product formulation as such comprising or consisting of the composition according to the invention, i.e. the composition according to the first aspect of the present invention, the composition according to the second aspect of the present invention and/or the composition obtained based on the process according to the third aspect of the present invention.

The inventive powder or pastille allow for the efficient incorporation of active ingredients into solid product formulations allowing for an efficient and targeted release of said active ingredients.

### EXAMPLES

Hereinafter, the present invention is described in more detail and specifically with reference to the examples, which however are not intended to limit the present invention.

### Example 1: Microcapsules Crystallized in Sodium Sulfate and Incorporated in Powder Detergent—Sensory Evaluation

According to a first example a composition comprising or consisting of at least one pastille comprising microcapsules was prepared as follows: anhydrous sodium sulfate was mixed with a microcapsule slurry (40% pure microcapsules; capsule to water ratio of 2:3) in a ratio of 1:1 by weight. The mixture was heated to 45° C. until a viscous mass was obtained. The mixture was then dripped and inoculated using seed crystals (anhydrous sodium sulfate) to obtain pastilles according to the invention. The microcapsules are based on a Melamine Formaldehyde capsule wall encapsulating a fragrance mixture. All microcapsules have a particle size in the range of 10 to 70 μm.

In the context of present invention, a powder or pastilles according to the invention could be denoted as microcapsules which are crystallized in an anhydrous salt as mentioned in present disclosure.

The sensory evaluation was performed as follows: Once the pastilles according to the present invention were prepared as described above, the pastilles were combined with commercially available powder detergent and homogenized. The final dosage of the microcapsules in 40 g of the powder detergent was 0.2% by weight (corresponding to 0.8% by weight of pastilles in 40 g of the powder detergent).

Finally, the product was added to the laundry machine and the fabrics (terry cloth) washed at 30° C.

After rinsing the fabrics were air dried at room temperature (line-dried).

A corresponding powder detergent was used as reference wherein the microcapsules where directly added to the powder detergent.

The fragrance release was carried out in three steps. The first step describes the smelling of an untreated cloth dry cloth (“pre-rub”). The second step describes the smelling of a lightly kneaded dry cloth; for this purpose, the cloth was subjected to slight mechanical stress by moving it back and forth between the hands several times, causing the capsules to break. The third step describes the smelling after the dry cloths were rubbed strongly and thus the capsules broke. After each step, the fragrance intensity was evaluated.

In order to evaluate the sensory performance, 8 to 9 test persons assessed the fragrance intensity on a scale of 1 (no odour) to 9 (very strong odour).

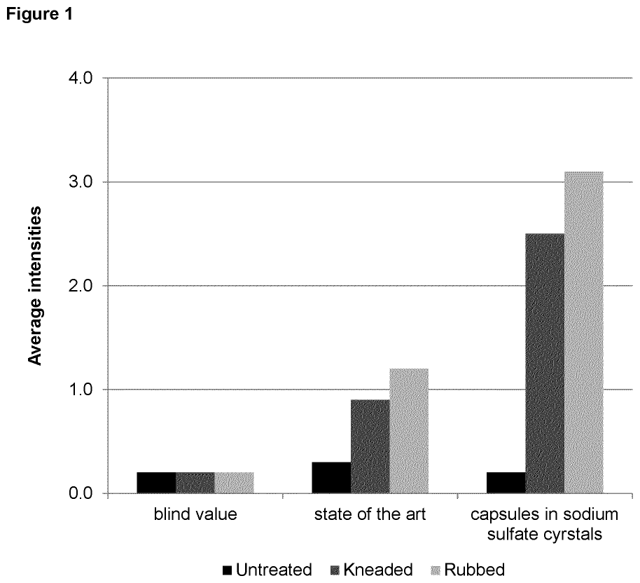

The results of the sensory evaluation are shown in FIG. 1.

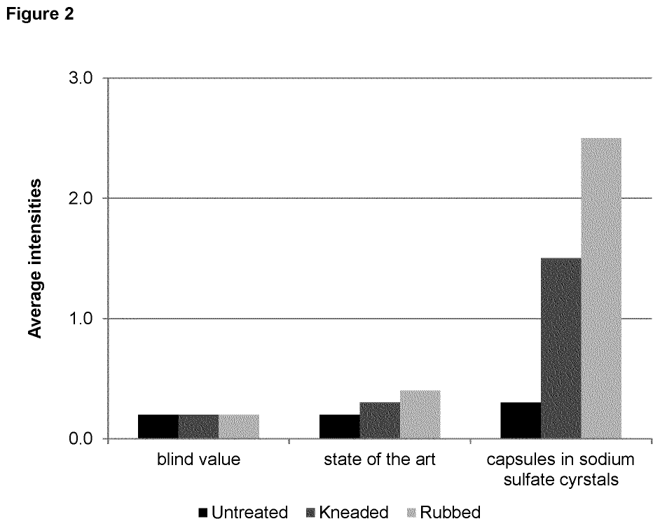

The samples comprising pastilles according to the present invention comprising the microcapsules embedded in a protective crystal matrix, for example sodium sulfate crystals (see FIGS. 1 and 2) show a considerably increased performance indicating an efficient protection of the fragile microcapsules within the crystals while simultaneously allowing for an efficient release of the active ingredient. The sodium sulfate crystals serve as a shock absorbing layer in the production process of the consumer product. Samples not containing such a shock absorbing layer and such comprising a mere coating do not perform as most of the microcapsules are already destroyed during the preparation of the consumer product.

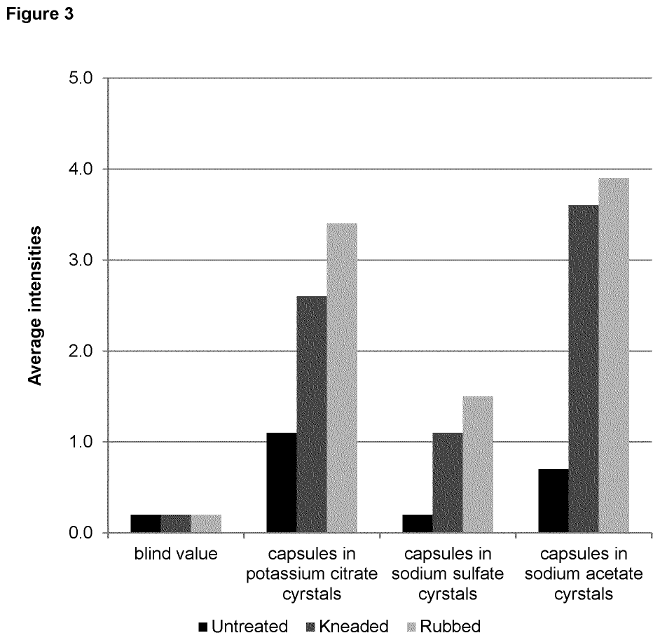

Surprisingly, it was found that best sensory results were obtained using anhydrous sodium acetate. Further, very good sensory results are obtainable using anhydrous potassium citrate (see FIG. 3).

However, it was important to exclusively use water-free salts such as water-free sodium acetate (not present as hydrate).

### Example 2: Microcapsules Crystallized in Sodium Sulfate and Incorporated in Laundry Soap—Sensory Evaluation

A plurality of pastilles in which microcapsules are embedded was prepared according to the process described in Example 1.

The sensory evaluation was performed as follows: Once the composition according to the present invention was prepared the as-obtained pastilles were combined with commercially available laundry soap in the form of soap particles and the resulting mixture passed through an extruder and the final soap cut into pieces.

The as-prepared laundry soap was then applied to damp fabrics (terry cloth) by rubbing. After rinsing the fabrics were air dried at room temperature.

A corresponding laundry soap not comprising the inventive composition comprising perfumed microcapsules was used as reference.

Subsequently, a commercially available powder deterged was mixed with the as-prepared pastilles and homogenized.

Finally, the product was added to the laundry machine and the and the cloths washed at 30° C. followed by air-drying at room temperature.

The sensory evaluation was performed according to example 1. The results of the sensory evaluation are shown in FIG. 2.

All samples show a significant improvement in the performance based on a buffer function of the crystallized sodium sulfate in the consumer product preparation process. Non-protected microcapsules are destroyed upon mixing and homogenization with the powder detergent and are thus not suitable for the preparation of a perfumed laundry soap.

### Example 3: Influence of Different Humectants

A plurality of pastilles according to the present invention was prepared according to the process described in Example 1. The composition comprised 75% by weight of salt (sodium sulfate) and 25% by weight of a microcapsule slurry (comprising 40% by weight of microcapsules based on the total weight of the slurry, i.e. a capsule load of 40% by weight) based on the total weight of the composition. These samples contained 0% by weight of a humectant (moisturizer).

The amount of the humectant was increased stepwise by simultaneously reducing the corresponding amount of salt in order to show the influence of the humectant (sorbitol) component on the final product (see Table 1).

TABLE 1

| | Salt | Slurry | Humectant | |
|---|---|---|---|---|
| Sample | [wt %] | [wt %] | [wt %] | Observation |
| 1 | 75 | 25 | 0 | Good result |
| 2 | 74 | 25 | 1 | Very good result |
| 3 | 72.5 | 25 | 2.5 | Very good result |
| 4 | 70 | 25 | 5 | No crystallization |

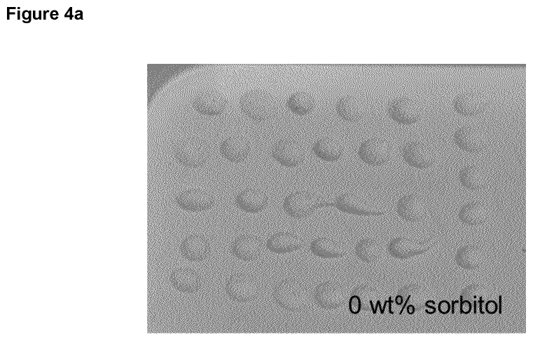

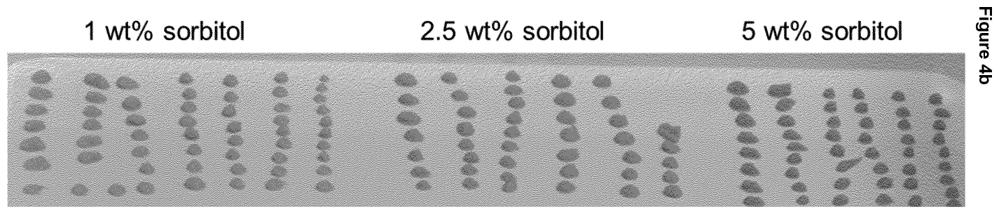

The results are shown in FIGS. 4a (0% humectant) and 4b (1%, 2.5% and 5%). The samples 2 and 3 did show excellent results. For sample 1 also good results were achieved. No crystallization was observed for the sample comprising 5% by weight of the humectant sorbitol.

Additionally, it was found that the addition of small amounts of a humectant contribute to an improved long-term stability, i.e. the pastilles keep their structure over time and do not “crumble” or fall apart.

Accordingly, it can be concluded that the proportion of the humectant should range from 0% to 2.5% by weight based on the total weight of the pastille or powder in order to achieve excellent products with improved stabilities and performances over time. Particularly good long-term results were achieved for the presence of a humectant in amounts of 1% to 2.5% by weight based on the total weight of the pastille or powder.

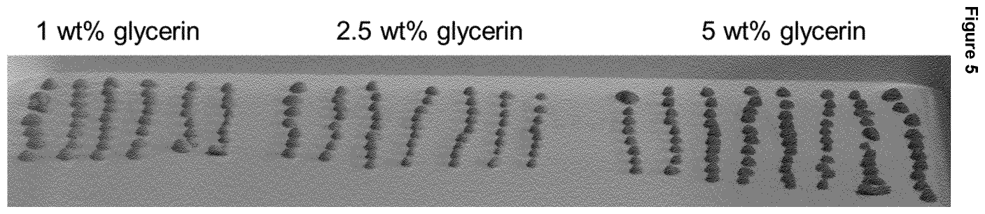

The same experiment was also conducted with glycerol instead of sorbitol. The results are shown in FIG. 5 (1%, 2.5% and 5%). Only the samples 2 and 3 did show sufficient results. No crystallization was observed for the sample comprising 5% by weight of the humectant glycerol.

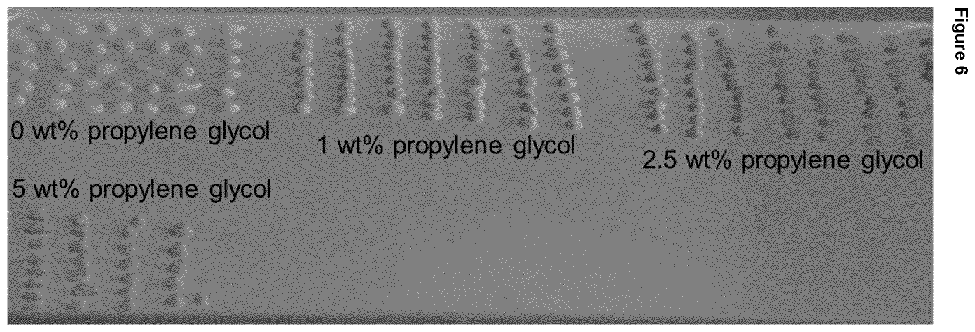

The same experiment was also conducted with propylene glycol instead of sorbitol. The results are shown in FIG. 6 (0%, 1%, 2.5% and 5%). Only the samples 2 and 3 did show sufficient results. No crystallization was observed for the sample comprising 5% by weight of the humectant propylene glycol.

It was found that the presence of the humectant critically influences the crystallization behaviour of the compositions.

### Example 4: Influence of the Salt

A plurality of pastilles according to the present invention was prepared according to the process described in Example 1.

The composition comprised 72.5% by weight of salt (sodium sulfate), 25% by weight of a microcapsule slurry (comprising 40% by weight of microcapsules based on the total weight of the slurry, i.e. a capsule load of 40% by weight) and 2.5% of humectant (propylene glycol) based on the total weight of the composition.

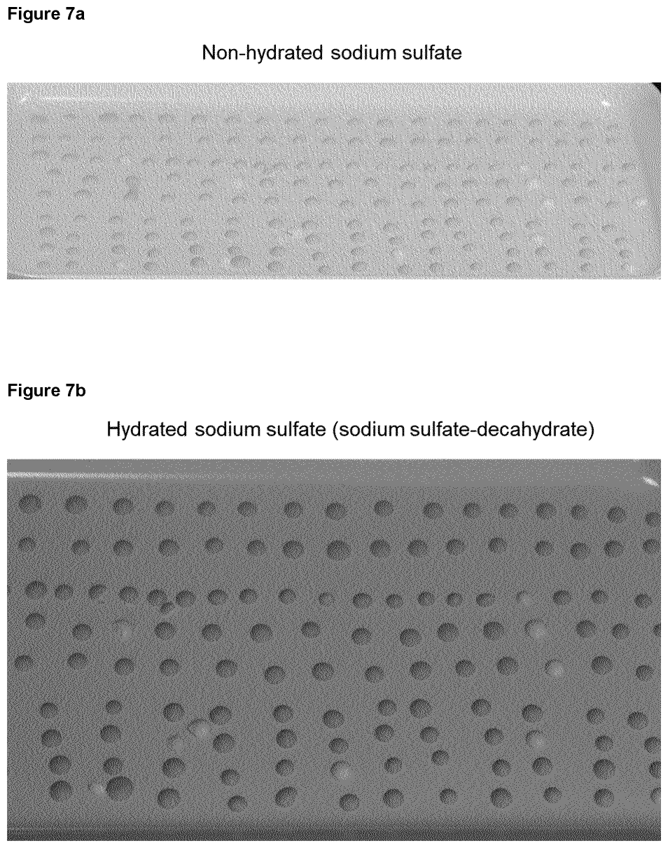

In on example, the salt was non-hydrated sodium sulfate (see FIG. 7a) and in another hydrated sodium sulfate (sodium sulfate-decahydrate) (see FIG. 7b).

The results show that non-hydrated salts provide for better crystallization results. The product was more difficult to handle. On the one hand, the desired crystal structure was almost not formed and on the other hand, the resulting product was consequently also significantly moister and stickier overall. No powder or pastilles could be obtained. Such a product could not be incorporated into a powder formulation such as a powder detergent. Mixing immediately caused the final consumer product formulation to clump. Accordingly, non-hydrated salts are preferred within the scope of the present invention.

The crystallization process of sodium sulfate was exploited. For this purpose, anhydrous sodium sulfate and the capsule slurry were mixed. The water in the capsule slurry formed a viscous but pluggable substance. By inoculation with crystals, a solid product could be developed. Sodium sulfate decahydrate however dissolves in its own crystallization water at 32° C. Consequently, no stable pastilles could be obtained when using the hydrated form of the salt.

It was thus found that it is disadvantageous if the salt, e.g. sodium sulfate, dissolves in its own water of crystallization. As stated above, this does not lead to the desired product and the formation of pastilles is not possible, let alone the incorporation into a powdered consumer product formulation.

The use of anhydrous salts, on the other hand, allows for the preparation of a sort of paste that is easy to handle and can easily be processed into pastilles that can be stably incorporated into a powdered consumer product formulation.

### Example 5: Influence of Seeding

Additionally, in a further example the crystallization behaviour was analysed in dependence of the seeding.

For this purpose, two different compositions were prepared based on the following composition: 75 wt % salt (sodium sulfate), 25% microcapsules.

The composition comprised 75% by weight of salt (sodium sulfate) and 25% by weight of a microcapsule slurry (comprising 40% by weight of microcapsules based on the total weight of the slurry, i.e. a capsule load of 40% by weight) based on the total weight of the composition. These samples contained 0% by weight of a humectant (moisturizer).

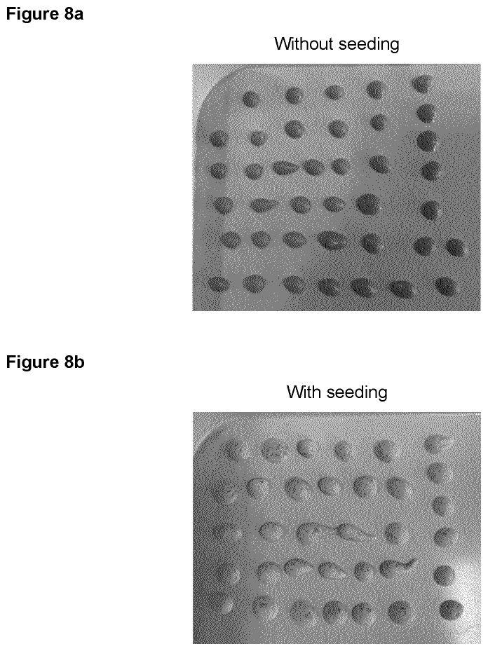

On the one hand, pastilles were prepared according to the process described in Example 1 using seed crystals (anhydrous sodium sulfate). The results are shown in FIG. 8b (with seeding).

On the other hand, pastilles were prepared according to the same process, but without seeding, i.e. without adding seed crystals. The results are shown in FIG. 8a (without seeding).

As can be seen from the figures, no crystallization was observed for the samples prepared without seeding. No pastilles could be achieved but rather wet and uncrystallized droplets. The product was more difficult to handle. On the one hand, the desired crystal structure was almost not formed and on the other hand, the resulting product was consequently also significantly moister and stickier overall. No powder or pastilles could be obtained. Such a product could not be incorporated into a powder formulation such as a powder detergent. Mixing immediately caused the final consumer product formulation to clump.

However, the addition of seed crystals provides for a full crystallization and thus results in the formation of stable pastilles. Accordingly, it can be concluded that seeding is required for a sufficient crystallization and thus for the formation of pastilles according to the present invention. The pastilles were easy to handle and can be stably incorporated into a powdered consumer product formulation.

Moreover, it was found that seeding allows for the formation of a homogenous and stable crystal salt matrix embedding the fragile microcapsules while simultaneously allowing for an efficient and targeted release of the active ingredients encapsulated in said microcapsules.

Furthermore, it was found that seeding also has a significant effect on the reaction rate. During slow precipitation, i.e. slow formation of the salt matrix, the fragile capsules are pushed outwards. This results in an inhomogeneous capsule distribution. The fine and fragile capsules are thus not as well protected against external influences such as pressure and the like.

Surprisingly, it was found that seeding with a seed crystal significantly accelerates the formation of the salt matrix and contributes to a homogeneous distribution of the fragile capsules within this protective matrix. The microcapsules are thus much better protected, without negatively influencing the release properties.

Seeding influences the crystallization behaviour and thus also the final crystalline structure and therefore also the overall structure of the resulting composition according to the present invention. Crystals obtained via seeding show different properties compared to crystals which did not contain any seed crystals, especially in terms of stability.

### Example 6

In another example pastilles according to the present invention were prepared as follows:
1) Providing 25 g of sodium sulfate (water free)—component (a);
2) Adding 16 g of a capsule slurry (comprising melamine-formaldehyde based microcapsules in a concentration of 40% by weight; capsule to water ratio of 2:3)—component (b);
3) Adding 0.2 g of C18-C22 hydroxyalkyl hydroxypropyl guar (stabilizer);
4) Heating the mixture to 45° C. in a water bath;
5) Adding a very thin layer of sodium sulfate (water free) for seeding;
6) Forming small droplets of the mixture; and
7) Adding the as-obtained pastilles to the final product formulation (washing detergent).

C18-C22 hydroxyalkyl hydroxypropyl guar was added as stabilizer.

Additionally, pastilles comprising microcapsules without a protecting salt layer were prepared for comparison.

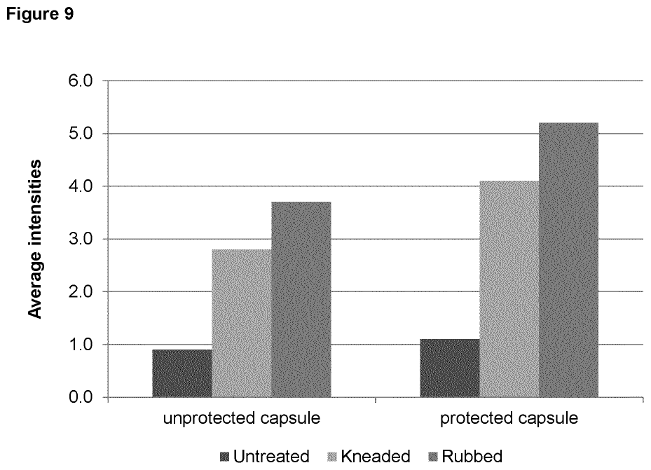

The results of the sensory evaluation are shown in FIG. 9 (left: no protective salt matrix, right: with protective salt matrix according to the present invention).

The results show that a protection of the fragile microcapsules according to the present invention considerably improves the olfactoric properties of the final product formulation. It was possible to further improve this effect by adding a stabilizer.

1. Process for the preparation of a powder or of a pastille comprising a plurality of microcapsules containing one or more ingredients, comprising the following steps:
(i) mixing (a) at least one anhydrous alkaline earth or alkali metal salt or a mixture of at least one anhydrous alkaline earth metal salt and at least one anhydrous alkali metal salt, (b) at least one capsule slurry or at least one capsule, and (c) optionally at least one humectant, wherein the humectant is propylene glycol, ethylene glycol, dipropylene glycol, glycerol, sorbitol or maltitol, or a mixture thereof;
(ii) heating the mixture obtained in step (i) and generating a melt;
(iii) dropping the melt produced in step (ii) onto a surface of an object;
(iv) seeding and optionally cooling the melt dropped in step (iii) in order to at least partially crystallize the dropped melt; and
(v) collecting the obtained powder or pastille.

2. Process for the preparation of a powder or of a pastille according claim 1, wherein the proportion of the alkaline earth and/or alkali metal salt is 20% to 99% by weight, the proportion of the capsule is 10% to 70% by weight or the proportion of the capsule slurry is 1% to 80% by weight, and optionally the proportion of the humectant is 0% to 2.5% by weight based on the total weight of the pastille or powder.

3. Process for the preparation of a powder or of a pastille according to claim 1, wherein the heating step (ii) is conducted at a temperature in the range from 40° C. to 80° C.

4. Process for the preparation of a powder or of a pastille according to claim 1, wherein the surface of the object is cooled before and/or during dropping.

5. Process for the preparation of a powder or of a pastille according to claim 1, wherein the alkaline earth or alkali metal salt or mixture thereof is anhydrous lithium sulfate and/or lithium acetate and/or lithium citrate and/or lithium phosphate and/or lithium oxalate and/or sodium sulfate and/or sodium acetate and/or sodium citrate and/or sodium phosphate and/or sodium oxalate and/or potassium sulfate and/or potassium acetate and/or potassium citrate and/or potassium phosphate and/or magnesium oxalate and/or magnesium sulfate and/or magnesium acetate and/or magnesium citrate and/or magnesium phosphate and/or magnesium oxalate and/or calcium sulfate and/or calcium acetate and/or calcium citrate and/or calcium phosphate and/or calcium oxalate.

6. Process for the preparation of a powder or of a pastille according to claim 1, wherein the at least one humectant is a polyol.

7. Process for the preparation of a powder or of a pastille according to claim 1, wherein the one or more ingredient is selected from the group consisting of odorants, fragrances, scents, perfume oils, flavourings, cosmetic ingredients, pharmaceutical active ingredients, insect repellents, ingredients for oral and dental care products, latent heat storage media and adsorbents.

8. Process for the preparation of a powder or of a pastille according to claim 7, wherein the one or more ingredient is an odorant or fragrance or a perfume oil and is added in a proportion of 0% to 10% by weight based on the total weight of the pastille or powder.

9. Process for the preparation of a powder or pastilles according to claim 1, wherein the at least one capsule has a wall material comprising one or more of the substances selected from the group consisting of natural, semi-synthetic and fully synthetic shell materials.

10. A powder or a pastille comprising:
(a) at least one anhydrous alkaline earth or alkali metal salt or a mixture of at least one anhydrous alkaline earth metal salt and at least one anhydrous alkali metal salt,
(b) at least one capsule slurry or at least one capsule containing one or more ingredients, and
(c) at least one humectant, wherein the humectant is propylene glycol, ethylene glycol, dipropylene glycol, glycerol, sorbitol, maltitol, or a mixture thereof.

11. The powder or a pastille according to claim 10, wherein the powder particles of the powder or the pastille each have a diameter ranging from 100 μm to 1 cm.

12. The powder or a pastille according to claim 10, wherein the powder particles of the powder or the pastilles each have a weight ranging from 0.5 mg to 25 mg.

13. A consumer product selected from the group consisting of detergents, cleaning agents, personal care products, nutritional preparations, recreational preparations, cosmetic preparations, pharmaceutical preparations, perfumed products, and products to be perfumed, wherein the consumer product comprises a powder or a pastille according to claim 10.

14. A method of perfuming a consumer product comprising formulating the consumer product with the powder or pastille according to claim 10.

15. The process according to claim 5, wherein the alkaline earth or alkali metal salt or mixture thereof is sodium sulfate and/or sodium acetate and/or potassium citrate.

16. The process according to claim 6, wherein the polyol is an aliphatic polyol.

17. The process according to claim 6, wherein the polyol is propylene glycol, ethylene glycol, dipropylene glycol, glycerol, sorbitol, maltitol, or a mixture thereof.

18. The process according to claim 8, wherein the one or more ingredient is added in a proportion of 0% to 6% by weight based on the total weight of the pastille or powder.

19. The process according to claim 9, wherein the at least one capsule has a wall material comprising one or more of melamine-formaldehyde resins, gelatine, alginates, polyurethanes, polyamides, and polyureas.

20. The powder or pastille according to claim 11, wherein the powder particles of the powder or the pastille each have a diameter ranting from 500 μm to 3 mm and/or each have a weight ranging from 1 mg to 5 mg.

21. The powder or pastille according to claim 10, wherein the proportion of the alkaline earth and/or alkali metal salt is 20% to 99% by weight, the proportion of the capsule is 10% to 70% by weight or the proportion of the capsule slurry is 1% to 80% by weight, and the proportion of the humectant is 0.1% to 2.5% by weight based on the total weight of the pastille or powder.

22. The powder or pastille according to claim 10 wherein the alkaline earth or alkali metal salt or mixture thereof is anhydrous lithium sulfate and/or lithium acetate and/or lithium citrate and/or lithium phosphate and/or lithium oxalate and/or sodium sulfate and/or sodium acetate and/or sodium citrate and/or sodium phosphate and/or sodium oxalate and/or potassium sulfate and/or potassium acetate and/or potassium citrate and/or potassium phosphate and/or magnesium oxalate and/or magnesium sulfate and/or magnesium acetate and/or magnesium citrate and/or magnesium phosphate and/or magnesium oxalate and/or calcium sulfate and/or calcium acetate and/or calcium citrate and/or calcium phosphate and/or calcium oxalate.

23. The powder or pastille according to claim 10 wherein the at least one humectant is a polyol.

24. The powder or pastille according to claim 10 wherein the one or more ingredients is selected from the group consisting of odorants, fragrances, scents, perfume oils, flavourings, cosmetic ingredients, pharmaceutical active ingredients, insect repellents, ingredients for oral and dental care products, latent heat storage media and adsorbents.

25. The powder or pastille according to claim 10 wherein the one or more ingredients is an odorant or fragrance or a perfume oil and is added in a proportion of 0% to 10% by weight based on the total weight of the pastille or powder.

26. The powder or pastille according to claim 10 wherein the at least one capsule has a wall material comprising one or more of the substances selected from the group consisting of natural, semi-synthetic and fully synthetic shell materials.
